(19) United States
(12) Patent Application Publication
(10) Pub. No.: US 2012/0129636 A1
(43) Pub. Date: May 24, 2012

(54) FRICTION REDUCING DEVICE OF TIMING CHAIN FOR VEHICLE

(75) Inventors: Seung Woo Lee, Seoul (KR); Sung Hwan Oh, Suwon-si (KR); Sung Chul Cha, Seoul (KR); Hong-Kil Baek, Seoul (KR)

(73) Assignees: Kia Motors Corporation, Seoul (KR); Hyundai Motor Company, Seoul (KR)

(21) Appl. No.: 13/189,091

(22) Filed: Jul. 22, 2011

(30) Foreign Application Priority Data
Nov. 19, 2010 (KR) 10-2010-0115870

(51) Int. Cl. F16H 7/08; F16H 7/18

(52) U.S. Cl. 474/111

(57) ABSTRACT

Friction reducing units are integrally configured in a tensioner arm and a chain guide that are disposed at both sides of a timing chain to make contact with the timing chain, respectively to increase the thickness of the oil film, such that it is possible to improve durability of an entire timing chain system while preventing noise from being generated by reducing a friction loss generated on each of contact surfaces of the tensioner arm and the chain guide and prevent fuel efficiency of the vehicle from being deteriorated.

Provided is a friction reducing device of a timing chain for a vehicle in a timing chain system including a tensioner arm and a chain guide disposed at both sides of a timing chain interconnecting a crank sprocket mounted a crank shaft and a cam sprocket mounted on the cam shaft so as to transfer a rotational force of the crank shaft to a cam shaft, respectively to prevent the timing chain from being separated while reducing vibration of the timing chain, wherein the tensioner arm and the chain guide further include first and second friction reducing units integrally formed, respectively in order to reduce a friction loss by increasing the thickness of an oil film between each of contact surfaces that make sliding-contact with the timing chain.

### CROSS-REFERENCE TO RELATED APPLICATION

This application claims priority to Korean Patent Application Number 10-2010-0115870 filed Nov. 19, 2010, the entire contents of which application is incorporated herein for all purposes by this reference.

### BACKGROUND OF INVENTION

1. Field of Invention

The present invention relates to a friction reducing device of a timing chain for a vehicle, and more particularly, to a friction reducing device of a timing chain for a vehicle that includes a tensioner arm and a chain guide that are disposed at both sides of the timing chain to make contact with the timing chain so as to reduce a friction loss generated by making contact with the timing chain.

2. Description of Related Art

In general, a vehicle acquires a driving force by combustion gas exploded in a cylinder of an engine and an intake valve and an exhaust valve are disposed in the cylinder to suction and discharge the combustion gas.

Therefore, the intake and exhaust valves are opened and closed at a predetermined time by a cam installed on a cam shaft. The cam shaft acts through a timing chain connected with a crank shaft.

That is, a chain system employing the timing chain is configured to transfer a rotational force of the crank shaft by connecting a crank sprocket mounted on the crank shaft and a cam sprocket mounted on each cam shaft through the timing chain.

Herein, since the timing chain transfers rotation to each sprocket spaced apart therefrom by a predetermined distance, when the timing chain rotates at a high speed, vibration is generated.

As a result, in the related art, by installing a tensioner arm and a chain guide at one portion and the other portion of the timing chain connecting the crank shaft and the cam shaft, respectively, a phase difference between the crank shaft and the cam shaft is compensated so that an intake valve and an exhaust valve are smoothly opened and closed in time for a combustion time and the timing chain is prevented from being separated while reducing the vibration of the timing chain.

However, the tensioner arm and the chain guide in the related art make direct contact with the timing chain, such that a large friction loss is generated due to a sliding friction resistance to generate noise and deteriorate overall durability of the timing chain system at the time when the timing chain rotates.

Further, the friction loss acts as a factor exerting a bad influence upon fuel efficiency to cause the fuel efficiency of the vehicle to be deteriorated in travelling, and as a result, marketability of the vehicle is also deteriorated.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to provide a friction reducing device of a timing chain that reduces a friction loss generated on a contact surface of each of a tensioner arm and a chain guide by increasing the thickness of an oil film by integrally configuring a friction reducing unit in each of the tensioner arm and the chain guide that make contact with a timing chain.

One aspect of the present invention provides for a friction reducing device of a timing chain for a vehicle in a timing chain system including a tensioner arm and a chain guide disposed at both sides of a timing chain interconnecting a crank sprocket mounted a crank shaft and a cam sprocket mounted on the cam shaft so as to transfer a rotational force of the crank shaft to a cam shaft, respectively to prevent the timing chain from being separated while reducing vibration of the timing chain, wherein the tensioner arm and the chain guide further include first and second friction reducing units integrally formed, respectively in order to reduce a friction loss by increasing the thickness of an oil film between each of contact surfaces that make sliding-contact with the timing chain and the timing chain.

The first friction reducing unit may include: a first oil guide formed at each of both longitudinal sides of the contact surface of the tensioner arm; and a plurality of oil grooves which are formed to be concave on the contact surface of the tensioner arm between the first oil guides.

The first oil grooves may be formed in parallel in the longitudinal direction of the tensioner arm in the state where the first oil groove are spaced apart from each other in the width direction on the contact surface of the tensioner arm at predetermined intervals.

Each of the first oil grooves may be formed in a semi-spherical shape.

The second friction reducing unit may include: a second oil guide formed at each of both longitudinal sides of the contact surface of the chain guide; and a plurality of second oil grooves which are formed to be concave on the contact surface of the chain guide between the second oil guides.

The second oil grooves may be formed in parallel in the longitudinal direction of the chain guide in the state where the second oil groove are spaced apart from each other in the width direction on the contact surface of the chain guide at predetermined intervals.

Each of the second oil grooves may be formed in the semi-spherical shape.

According to various aspects of the present invention, a friction reducing device of a timing chain for a vehicle reduces a friction resistance by increasing the thickness of an oil film and improves fuel efficiency of the vehicle at the time when the timing chain rotates.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a configuration diagram of an exemplary timing chain system employing a friction reducing device of a timing chain for a vehicle according to the present invention.

FIG. 2 is a perspective view of an exemplary tensioner arm and chain guide employing a friction reducing device of a timing chain for a vehicle according to the present invention.

FIG. 3 is a cross-sectional perspective view taken along line A-A of FIG. 2.

FIG. 4 is a cross-sectional perspective view taken along line B-B of FIG. 2.

FIG. 5 is a diagram for describing the operation of an exemplary friction reducing device of a timing chain for a vehicle according to the present invention.

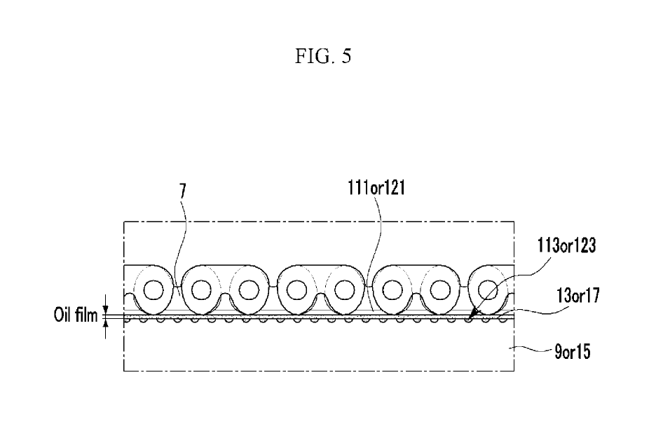

FIG. 6 is a graph showing an influence which a frictional coefficient and the thickness of an oil film exert upon a sliding velocity.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

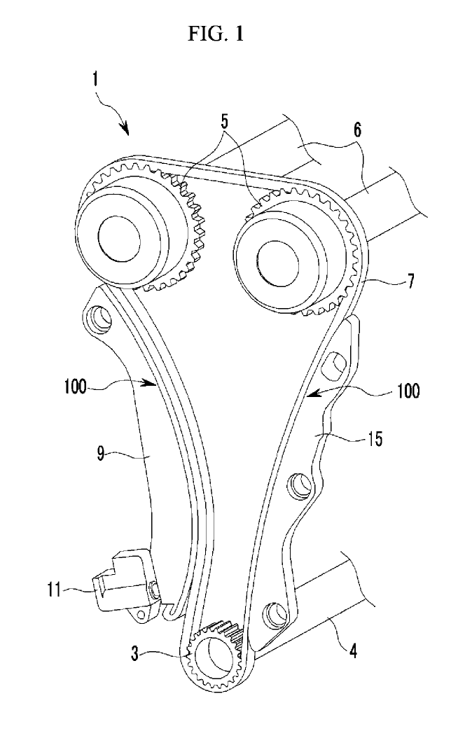

First, as shown in FIG. 1, a friction reducing device 100 of a timing chain for a vehicle according to various embodiments of the present invention includes a tensioner arm 9 and a chain guide 15 that are disposed at both opposing peripheral sides of a timing chain 7 interconnecting a crank sprocket 3 mounted on a crank shaft 4 and a cam sprocket 5 mounted on the cam shaft 6 so as to transfer a rotational force of the crank shaft 4 to the cam shaft 6, respectively to prevent the timing chain 7 from being separated while reducing the vibration of the timing chain 7.

In various embodiments, the tensioner arm 9 is disposed at the left side of the timing chain 7 on the basis of the figure and controlled by a chain tensioner 11 connected to the bottom of the tensioner arm 9 to adjust the tension of the timing chain 7.

In addition, the chain guide 15 is disposed at the right side of the timing chain 7 which is an opposite side to the tensioner arm 9 to guide the moving timing chain 7.

The friction reducing device 100 of the timing chain for the vehicle according to various embodiments of the present invention includes first and second friction reducing units 110 and 120.

Herein, the first and second friction reducing units 110 and 120 are integrally formed in the tensioner arm 9 and the chain guide 15, respectively to increase the thickness of an oil film between each of contact surfaces 13 and 17 of the tensioner arm 9 and the chain guide 15 which contact the timing chain 7.

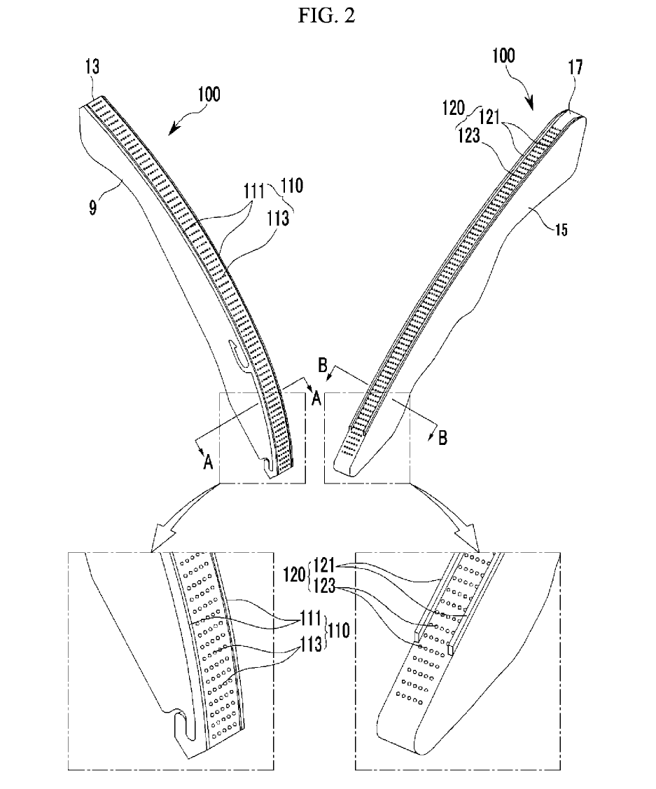

First, the first friction reducing unit 110 includes a first oil guide 111 and a first oil groove 113, as shown in FIG. 2.

The first oil guide 111 protrudes upward on both longitudinal sides of the contact surface 13 of the tensioner arm 9 to correspond to the timing chain 7.

Each first oil guide 111 guides oil supplied to the contact surface 13 of the tensioner arm 9 to flow on the contact surface 13 of the tensioner arm 9 to prevent the oil from being leaked in a width direction of the tensioner arm 9.

In addition, the plurality of first oil grooves 113 are formed to be concave on the contact surface 13 of the tensioner arm 9 between the first oil guides 111.

Herein, in the state where the first oil grooves 113 are spaced from each other in the width direction on the contact surface 13 of the tensioner arm 9 at predetermined intervals, the first oil grooves 113 may be formed in parallel in the length direction of the tensioner arm 9.

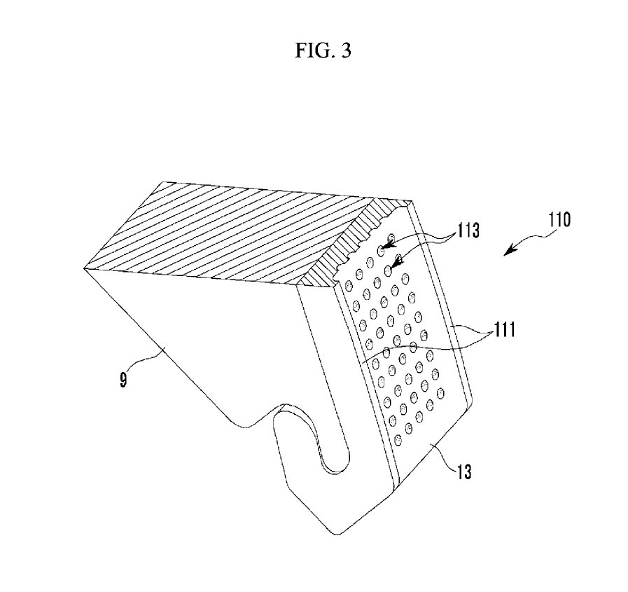

Each of the oil grooves 113 may be formed in a semi-spherical groove on the contact surface 13 of the tensioner arm 9, as shown in FIG. 3.

In various embodiments, the second friction reducing unit 120 includes a second oil guide 121 and a second oil groove 123, as shown in FIG. 2.

First, the second oil guide 121 protrudes upward on both longitudinal sides of the contact surface 17 of the chain guide 15 to correspond to the timing chain 7.

Each second oil guide 123 guides the oil supplied to the contact surface 17 of the chain guide 15 to flow on the contact surface 17 of the chain guide 15 to prevent the oil from being leaked in a width direction of the chain guide 15.

In addition, the plurality of second oil grooves 123 are formed to be concave on the contact surface 17 of the chain guide 15 between the second oil guides 121.

Herein, in the state where the second oil grooves 123 are spaced from each other in the width direction on the contact surface 17 of the chain guide 15 at predetermined intervals, the second oil grooves 123 may be formed in parallel in the length direction of the chain guide 15.

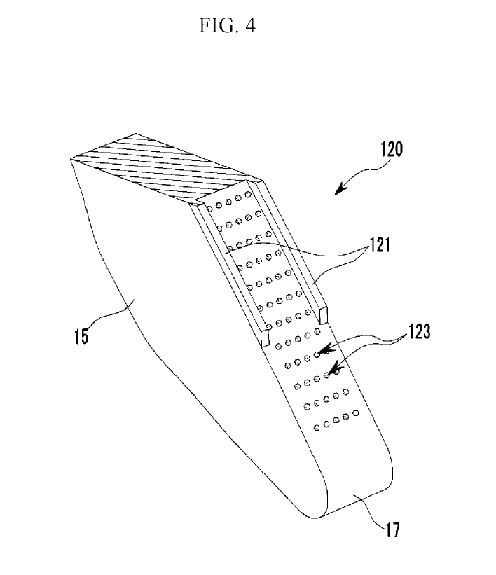

Each of the oil grooves 123 may be formed in a semi-spherical groove on the contact surface 17 of the chain guide 15, as shown in FIG. 4.

That is, the first and second friction reducing units 110 and 120 having the above configurations form oil films or layers between each unit and the timing chain 7 in the state where the oil supplied to each of the contact surfaces 13 and 17 of the tensioner arm 9 and the chain guide 15 that make contact with the timing chain 7 is stored through each of the first and second oil grooves 113 and 123.

Herein, when the timing chain 7 rotates, a cross section of each of the first and second oil grooves 113 and 123 is formed to be concave in a semi-spherical shape, such that the thickness of the oil film between the timing chain 7 and the tensioner arm 9 or the timing chain 7 and the chain guide 15 that move relatively by an acting vertical load increases.

Therefore, a frictional coefficient on each of the contact surfaces 13 and 17 of the tensioner arm 9 and the chain guide 15 decreases while boundary friction generated by a lack of the oil film between each contact surface and the timing chain 7 is changed to an elastohydrodynamic lubrication condition as the thickness of the oil film increases.

Herein, in general, the friction force is expressed by the product of the vertical load and the frictional coefficient. Therefore, since energy consumed by friction is expressed by the friction force and an acting area, when the vertical load and a friction area act with the same magnitude, it is possible to reduce an energy loss due to the friction by reducing the frictional coefficient.

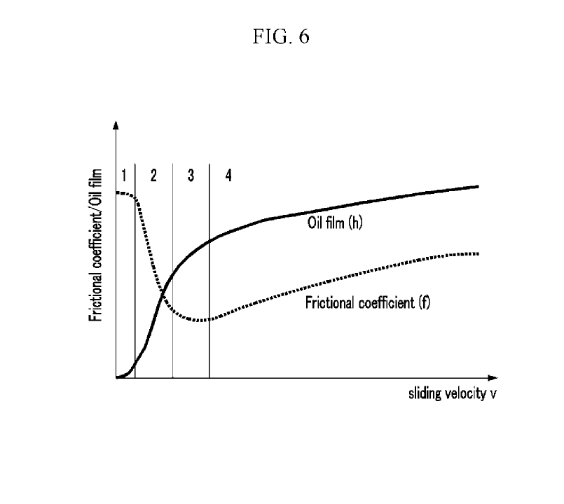

FIG. 6 is a graph showing the relationship between the frictional coefficient and the thickness of the oil film, and a sliding velocity. Referring to FIG. 6, as the thickness of the oil film increases, the frictional coefficient decreases.

That is, the frictional coefficient is large in region 1, while the frictional coefficient largely decreases although the sliding velocity increases in region 3 which is an elastohydrodynamic lubrication section where the thickness of the oil film increases.

For reference, in FIG. 6, region 2 represents a mixed friction section and region 4 represents a hydrodynamic lubrication section.

That is, in various embodiments, the oil stored in each of the first and second oil grooves 113 and 123 moves on each of the contact surfaces 13 and 17 by the vertical load acting when the timing chain 7 rotates, but the state in which the oil stored in each of the first and second oil grooves 113 and 123 that are successively formed is maintained constantly at all times.

As a result, the first and second friction reducing units 110 and 120 are maintained while the thickness of the oil film is increased between each of the contact surfaces 13 and 17 and the timing chain 7 to decrease the frictional coefficient.

When the frictional coefficient decreases, lost friction energy can be decreased, and as a result, a friction loss generated between the contact surfaces 13 and 17 of the tensioner arm 9 and the chain guide 15 that make contact with the timing chain 7 is minimized.

Accordingly, when the friction reducing device 100 of the timing chain for the vehicle according to various embodiments of the present invention configured as above is adopted, the friction reducing units 110 and 120 are integrally configured in the tensioner arm 9 and the chain guide 15 that are disposed at both sides of the timing chain 7 to make contact with the timing chain 7, respectively to increase the thickness of the oil film, such that it is possible to improve durability of the entire timing chain system 1 while preventing noise from being generated by reducing the friction loss generated on each of the contact surfaces 13 and 17 of the tensioner arm 9 and the chain guide 15.

Further, when the timing chain 7 rotates, a friction resistance is decreased by increasing the thickness of the oil film, and as a result, the friction loss is reduced, thereby preventing fuel efficiency of the vehicle from being deteriorated.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A friction reducing device of a timing chain system for a vehicle comprising:
a tensioner arm and a chain guide disposed at opposing peripheral sides of a timing chain interconnecting a crank sprocket mounted on a crank shaft and a cam sprocket mounted on the cam shaft so as to transfer a rotational force of the crank shaft to a cam shaft, respectively to prevent the timing chain from being separated while reducing vibration of the timing chain;
wherein the tensioner arm and the chain guide further include first and second friction reducing units integrally formed, respectively in order to reduce a friction loss by increasing the thickness of an oil film between each of contact surfaces that make sliding-contact with the timing chain.

2. The device of claim 1, wherein the first friction reducing unit includes:
a first oil guide formed at both longitudinal sides of the contact surface of the tensioner arm; and
a plurality of oil grooves which are formed to be concave on the contact surface of the tensioner arm between the first oil guides.

3. The device of claim 2, wherein the first oil grooves are formed in parallel in the longitudinal direction of the tensioner arm in the state where the first oil groove are spaced apart from each other in the width direction on the contact surface of the tensioner arm at predetermined intervals.

4. The device of claim 2, wherein each of the first oil grooves is formed in a semi-spherical shape.

5. The device of claim 1, wherein the second friction reducing unit includes:
a second oil guide formed at both longitudinal sides of the contact surface of the chain guide; and
a plurality of second oil grooves which are formed to be concave on the contact surface of the chain guide between the second oil guides.

6. The device of claim 5, wherein the second oil grooves are formed in parallel in the longitudinal direction of the chain guide in the state where the second oil groove are spaced apart from each other in the width direction on the contact surface of the chain guide at predetermined intervals.

7. The device of claim 5, wherein each of the second oil grooves is formed in a semi-spherical shape.
